(19) United States
(12) Patent Application Publication
(10) Pub. No.: US 2014/0122292 A1
(43) Pub. Date: May 1, 2014

(54) ELECTRONIC COMMERCIAL METHOD AND SYSTEM USING A PERSONAL WEBPAGE HAVING A PRICE BARCODE

(71) Applicants: Hyuk Il Kwon, Anyang-si (KR); Byung-Joon Cha, Incheon (KR); Geum Yu, Seoul (KR); Byung Wan Kim, Seoul (KR); Eun Ryung Hyun, Seoul (KR)

(72) Inventors: Hyuk Il Kwon, Anyang-si (KR); Byung-Joon Cha, Incheon (KR); Geum Yu, Seoul (KR); Byung Wan Kim, Seoul (KR); Eun Ryung Hyun, Seoul (KR)

(73) Assignee: LIFEGOOD, Seoul (KR)

(21) Appl. No.: 14/126,542

(22) PCT Filed: Jun. 15, 2012
(86) PCT No.: PCT/KR2012/004721

§ 371 Date: Dec. 16, 2013

(30) Foreign Application Priority Data
Jun. 15, 2011 (KR) 10-2011-0057856

(51) Int. Cl. G06Q 30/06

(52) U.S. Cl. CPC G06Q 30/0633
USPC 705/26.8

(57) ABSTRACT

The present invention relates to an electronic commercial method and system using a personal webpage having a price barcode. When a product is purchased online, a corresponding unique personal webpage is generated. The personal webpage is automatically removed by the use of the personal webpage, or an existing personal webpage is removed on a real-time basis when transferred to another user, thus preventing the forgery or falsification of a purchase history and improving the reliability and convenience of the transfer.

### TECHNICAL FIELD

The present invention is an electronic commercial method and system using a personal web page including an on/off-line interconnection-type price barcode.

The present invention is a resultant product developed by a business of supporting an institute affiliated with a company for Industry-University-Institute cooperation by the Small and Medium Business Administration of the Republic of Korea.

### BACKGROUND ART

In general, electronic commerce refers to an activity of buying and selling a product or a service online. Activities of selling, purchasing, or paying for electronic commerce are performed online. Especially, electronic commerce in a narrow sense refers to an activity of selling products in real time through a shop in the cyber world which is established as a home page in the Internet. The products on sale may include a service such as distance education and medical diagnosis or a digital product such as audio files and software. Further, electronic commerce in a large sense refers to not only dealing with consumers but also activities relating to all organizations including suppliers, financial institutions, governmental organizations, transportation and the like, which are related to commerce.

Meanwhile, recently, electronic commerce by which coupons including product purchase information actively used on electronic commerce are by through online download, and then a product is provided offline using the coupon is on the rise.

However, basically, online coupons like this can be easily forged or falsified, so online coupons have large problem in credibility. Also, a user who has a coupon does not know whether the coupon has been used or not until the user goes to a shop (for example, a cafe or a shop for commodities) from which the product is actually given, so it is inconvenient to use the coupons.

### DISCLOSURE OF INVENTION

### Technical Problem

The present invention has been conceived in order to solve the problems described above. The present invention is to provide an electronic commercial method and system using a personal web page including a price barcode in which a corresponding unique personal web page is formed when a product is purchased online, the personal web page is automatically removed by the usage of the personal web page, or the existing personal web page is removed in real time when the transfer to another user is performed so that the purchase list can be prevented from being forged or falsified and the credibility and convenience of the transfer can be improved.

### Solution to Problem

As means for solving the problems described above, an electronic commercial method using a personal web page including a price barcode according to an embodiment of the present invention includes connecting to a product purchase website using the wired/wireless Internet by a first user equipment; transmitting an authentication identifier of the first user equipment to a web server that provides the product purchase website for a purchase of a product by the first user equipment; determining whether the first user equipment is authenticated or not by comparing the authentication identifier received from the first user equipment and an authentication comparison identifier which is an authentication identifier previously registered and stored in a database of the web server, by the web server; authenticating the first user equipment by the web server when the received authentication identifier and the stored authentication comparison identifier are identical to each other, forming a personal web page including the authentication identifier and a price barcode of the product, and transmitting the personal web page to the first user equipment; receiving information obtained by scanning the price barcode of the product included in the personal web page of the first user equipment from the first user equipment by the Value-Added Network (VAN) server to perform a payment; requesting to remove the personal web page from the web server by the VAN server; and removing the personal web page by the web server.

According to another embodiment of the present invention, the electronic commercial method further includes changing the authentication identifier of the personal web page to an authentication identifier of a second user equipment by the first user equipment, and receiving the personal web page in which the authentication identifier is changed from the first user equipment by the web server to transmit the personal web page to the second user equipment, after the authenticating of the first user equipment.

According to still another embodiment of the present invention, the electronic commercial method further includes receiving information obtained by scanning the price barcode of the product included in the personal web page of the second user equipment from the second user equipment by the Value-Added Network (VAN) server, and performing a payment.

According to still another embodiment of the present invention, the receiving of the personal web page in which the authentication identifier is changed from first user equipment by the web server to transmit the personal web page to the second user equipment further includes receiving information of the changed personal web page by the web server, and including a URL of the personal web page on notification information notifying of the change of the personal web page to transmit the information to the second user equipment.

According to still another embodiment of the present invention, the including of the URL of the personal web page on notification information notifying of the change of the personal web page to transmit the information to the second user equipment further includes transmitting the notification information to the second user equipment using SMS or push notification by the web server.

According to still another embodiment of the present invention, the authentication identifier is a unique number of the first user equipment, a phone number, or a user ID and a password.

According to an embodiment of the present invention, an electronic commercial system using a personal page including a price barcode, includes a first user equipment that connects to a product purchase website using a wired/wireless Internet and transmits an authentication identifier for a purchase of a product; a web server that determines whether the first user equipment is authenticated or not by comparing the authentication identifier received from the first user equipment and an authentication comparison identifier which is an authentication identifier previously registered and stored in a database of the web server that provides a product purchase website, authenticates the first user equipment when the received authentication identifier and the previously stored authentication comparison identifier are identical to each other, forms a personal web page including the authentication identifier and a price barcode of the product, and transmits the personal web page to the first user equipment; and a Value-Added Network (VAN) server that receives information obtained by scanning the price barcode of the product included in the personal web page of the first user equipment to perform a payment and requests to remove the personal web page from the web server.

According to another embodiment of the present invention, the web server includes a database in which a plurality of authentication comparison identifiers of user equipments are previously registered and stored; an authentication processing unit that determines whether the first user equipment is authenticated or not by comparing the authentication identifier received from the first user equipment and authentication comparison identifiers previously registered and stored in a database of the web server, and authenticates the first user equipment when the received authentication identifier and the previously stored authentication comparison identifier are identical to each other; and a personal web page creating unit that forms a personal web page including the authentication identifier and a price barcode of the product, and transmits the personal web page to the first user equipment.

According to still another embodiment of the present invention, the personal web page creating unit receives data in which the authentication identifier of the personal web page is changed to an authentication identifier of a second user equipment, creates the personal web page by applying the received data, and transmits the created personal web page to the second user equipment, and the VAN server receives information obtained by scanning the barcode of the product included in the personal web page of the second user equipment from the second user equipment to perform a payment.

According to still another embodiment of the present invention, the authentication identifier is a unique number of the first user equipment, a phone number, or a user ID and a password.

### Advantageous Effects of Invention

The present invention has an effect in which a corresponding unique personal web page is formed when a product is purchased online, the personal web page is automatically removed by the usage of the personal web page, or the existing personal web page is removed in real time when the transfer to another user is performed so that the purchase list can be prevented from being forged or falsified and the credibility and convenience of the transfer can be improved.

Further, the applicability can be enhanced by applying a method of providing a barcode not only to electronic commerce but also to various discount coupons.

### BRIEF DESCRIPTION OF DRAWINGS

FIG. 1 is a diagram illustrating a schematic configuration of an electronic commercial system using a personal web page including a price barcode according to the present invention;

FIG. 2 is a diagram illustrating a detailed configuration of an electronic commercial system using a personal web page including a price barcode according to the present invention;

FIG. 3 is a flowchart illustrating an electronic commercial method using a personal web page including a price barcode according to an embodiment of the present invention; and

FIGS. 4 and 5 are diagrams illustrating a usage state of a price barcode usage according to an embodiment of the present invention.

### MODE FOR THE INVENTION

Embodiments of the present invention now will be described more fully hereinafter with reference to the accompanying drawings. In the description with reference to the accompanying drawings, the same elements will be designated by the same reference numerals although they are shown in different drawings. Further, a repetitive description thereof will be omitted. Although the terms first, second, etc. may be used herein to describe various elements, these elements should not be limited by these terms. These terms are only used to distinguish one element from another.

The present invention is to provide an electronic commercial method and system creating a personal web page including information of a product purchased online and using a personal web page including an on/off-line interconnection type price barcode that cannot be forged or falsified.

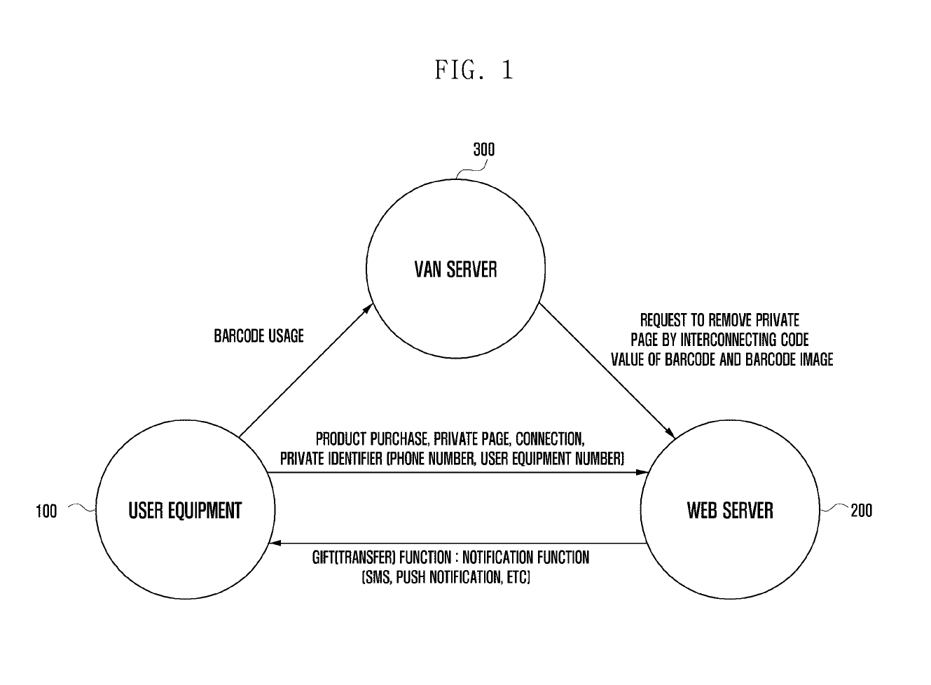

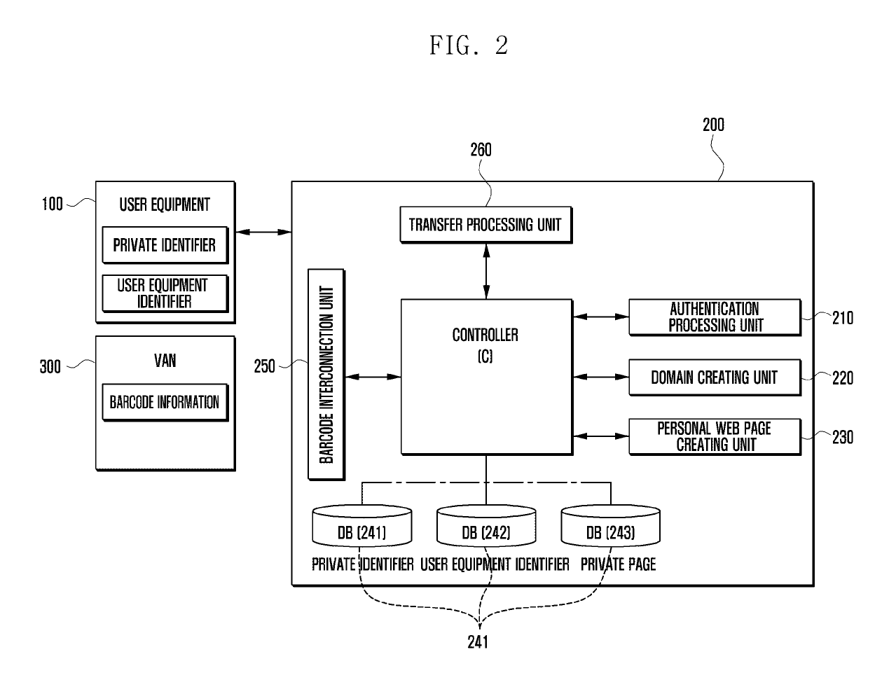

FIG. 1 is a diagram illustrating a schematic configuration of an electronic commercial system using a personal web page including a price barcode according to the present invention, and FIG. 2 is a diagram illustrating a detailed configuration of an electronic commercial system using a personal web page including a price barcode according to the present invention.

With reference to the accompanying drawings, the electronic commercial system using a personal web page including a price barcode according to the present invention may include a first user equipment 100 that performs wired/wireless communication, includes a unique number of a user equipment, a private identifier, or an ID and a password, and connects to a web server, a web server 200 that combines purchase information of a product purchased at a product purchase website by the first user equipment with the unique number, private identifier information, or a user ID and a password to form a personal web page, and a VAN server 300 that interconnects a barcode code value and a barcode image included in the personal web page when a product purchase is completed using the personal web page and requests to remove the personal web page from the web server.

The first user equipment 100 is a concept including a user equipment that can perform wired/wireless communication. Especially, various devices such as a PC, a mobile phone, and a PDA that can be connected to the Internet may be applied. For example, a mobile communication terminal using a wired/wireless communication network may be a user equipment. In this case, the user equipment uses such a mobile communication network and the Internet. Here, the Internet is a wirelessly accessible network which includes the wireless Internet which can be accessed through a mobile communication network based on a platform such as WAP (Wireless Application Protocol) or WIPI, or through a public wireless LAN and an Access Point (AP), and the mobile Internet (WiBro or WiMax) that can access the Internet at high speed while at a standstill or in a slow movement speed with a quality and cost comparable to ADSL. Meanwhile, if the mobile communication terminal has a function of wirelessly accessing the Internet, the mobile communication terminal can be connected to the web server 200 in substitution for a computer limited in mobility.

Further, the web server 200 to which the first user equipment 100 is connected configures a personal web page by combining information of a product purchased from a product purchase website by the first user equipment, a unique number of the first user equipment, a phone number, the user ID, and a password.

Specifically, the web server 200 may include at least one database 240 that stores an authentication comparison identifier for comparing a unique number of a user equipment of the first user equipment 100 with a phone number or a user ID and a password, a domain creating unit 220 that creates a domain through a unique number of the user equipment, a private identifier, or a user ID and a password, an authentication processing unit 210 that performs a user authentication through the unique number of the user equipment, the private number, or the user ID and the password, and a personal web page creating unit 230 that forms a personal web page by combining the unique number, the private identifier, or the user ID and the password with product purchase information.

The web server 200 may further include a barcode interconnection unit 250 that is interconnected to recognize whether the VAN server 300 uses a barcode of the personal web page or not, and a transfer processing unit 260 that removes an existing personal web page if the unique number, the private identifier, and the user ID and the password are changed.

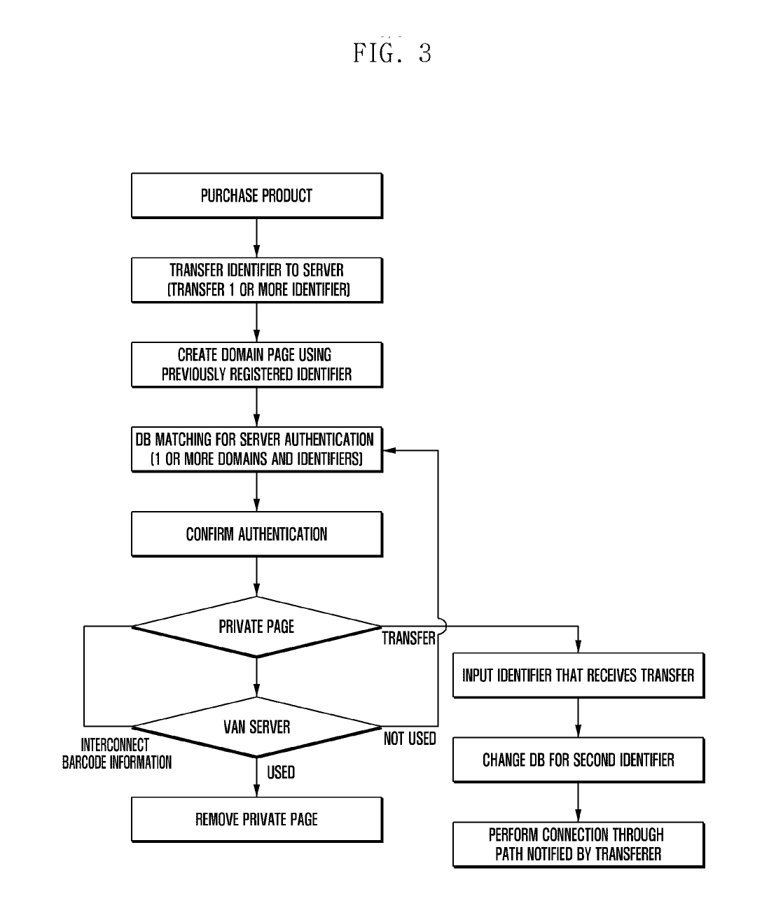

Hereinafter, an electronic commercial method that uses an electronic commercial system which uses a personal web page including the price barcode described above is described in detail with reference to FIGS. 2 and 3.

An electronic commercial method that uses a personal web page including a price barcode according to an embodiment of the present invention may include a first step of causing the first user equipment 100 to be connected to a product purchase website using a wired/wireless Internet to perform a product purchase, a second step of causing the first user equipment 100 to transmit an authentication identifier to the web server 200 when the product purchase is completed, and a third step of causing the web server 200 to form a personal web page through the authentication identifier.

That is, in the first and second steps, the first user equipment 100 is connected to the product purchase web site to purchase a product online, and transmits an authentication identifier of the first user equipment 100 to the web server 200 when the product purchase is completed. In this case, the authentication identifier may include a user equipment identifier which is a user equipment unique number, a private identifier which is a phone number, and a user ID and a password. The private identifier, the user equipment identifier, or the user ID and the password are stored in the databases 240 of the web server 200 described above.

The authentication processing unit 210 of the web server 200 compares the authentication identifier transmitted from the first user equipment with the authentication comparison identifier which is the authentication identifier registered and stored in advance to determine whether the first user equipment is identified or not. As a determination result, if the received authentication identifier is identical to the stored authentication comparison identifier, the first user equipment is authenticated. When the authentication is completed, the product purchase information including the product information and the price barcode is matched with the private identifier and the user equipment identifier so that the personal web page creating unit 230 creates a personal web page.

If the user scans a barcode and performs a purchase, the VAN server 300 interconnects a code value of the barcode and the barcode image in real time through the barcode interconnection unit 250 of the web server to request the web server to remove a used personal web page. The web server which has received a request immediately removes a personal web page from a controller C.

Especially, a specific method of using a barcode according to an embodiment of the present invention is to transfer a personal web page including the barcode and the product page of the product as described above to a third person. That is, when a personal web page created in the steps described above is transmitted to a user equipment of a third person (second user equipment), the authentication identifier of the personal web page is changed for the third person, and the personal web page existing in the first user equipment is removed.

This is described in detail as follows. The step of transferring a personal web page including product information purchased by the first user equipment 100 to a second user equipment includes causing the first user equipment to be connected to the product purchase website and to change an authentication identifier to information of the second user equipment. For example, if the first user equipment changes a phone number which is a private identifier to a phone number of the second user equipment, the phone number of the second user equipment is stored in a database of the web server. Thereafter, information on the change is transferred to the second user equipment by a notification function such as SMS and push notification.

Thereafter, if the second user equipment to which the changed information (such as URL) is transmitted is connected to the product purchase web page, a user equipment unique number which is one of authentication identifiers of the first user equipment is automatically changed to a unique number of the second user equipment. Thereafter, the changed authentication identifier of the second user equipment is re-matched to the personal web page so that the barcode and the product page of the purchased product are transferred. Of course, in this case, the personal web page stored in the first user equipment before the transfer is immediately removed through the transfer processing unit 260 of the web server so that only one personal web page remain. Through these processes, a credible deal can be performed without confirming whether the personal web page including the product purchase information is used and the transfer is performed.

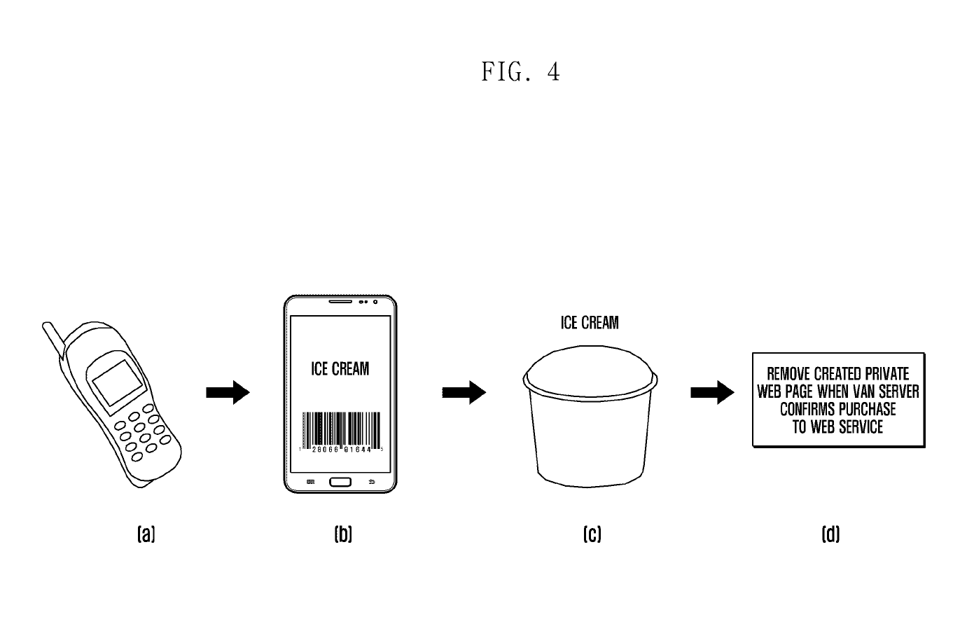

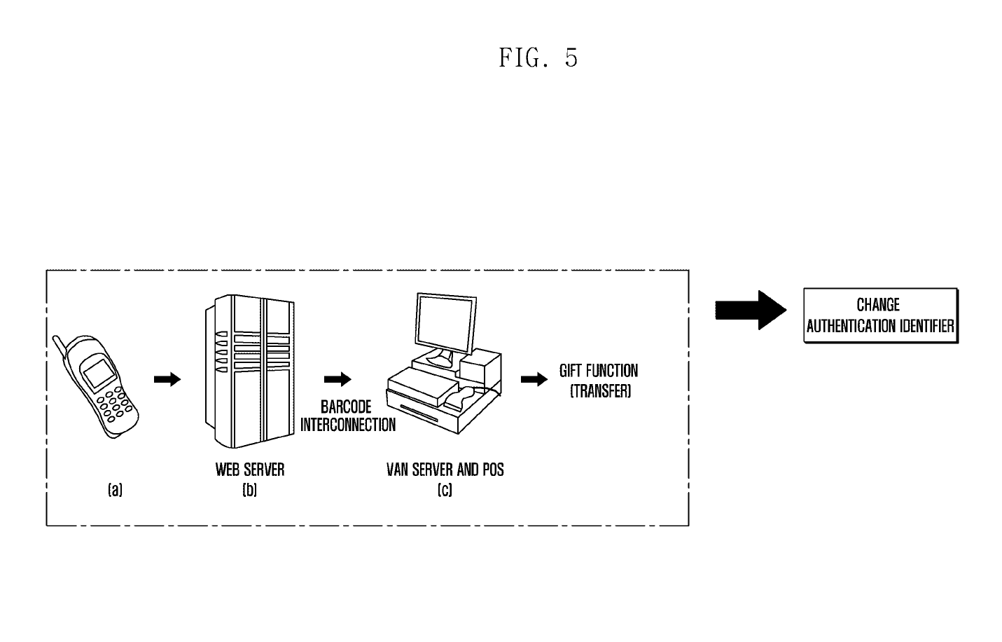

FIGS. 4 and 5 are diagrams illustrating a usage state of a price barcode usage according to an embodiment of the present invention.

First, if a product is purchased from the website by a user equipment as illustrated in FIG. 4A, a personal web page is created and price barcode information included in a personal web page is interconnected in a VAN server as illustrated in FIG. 4B. Thereafter, if the price barcode information is scanned in a Point Of Sales (POS) system as illustrated in FIG. 4C, the price barcode information is received by the VAN server to confirm a purchase. As soon as the purchase is confirmed, a previously created personal web page is removed through the interconnection with the web server.

Further, as illustrated in FIG. 5, after the product purchase is completed and the personal web page is created, the user equipment is re-connected to the web server, the web server matches with the authentication identifier to confirm the authentication and checks whether the personal web page is created thereafter. As described above, when the transfer to the third person is performed, this process enables the private identifier and the user equipment unique number to be changed, and the personal web page and the changed information to be matched and stored.

In the electronic commercial method using a personal web page including a price barcode according to an embodiment of the present invention, a corresponding unique personal web page is formed when a product is purchased online, the personal web page is automatically removed by the usage of the personal web page, or the existing personal web page is removed in real time when the transfer to another user is performed so that the purchase list can be prevented from being forged or falsified and the credibility and convenience of the transfer can be improved. Further, the electronic commercial method using the personal web page including the price barcode can be applied not only to electronic commerce of a product purchase but also to a discount coupon.

In the detailed description of the present invention as described above, specific embodiments are described. However, various modifications can be performed without departing from the scope of the present invention. The technical idea of the present invention may not be limited by the embodiments of the present invention as described above but to be defined by the claims of the present invention or the equivalents thereof.

1. An electronic commercial method using a personal page including a price barcode, comprising:
connecting to a product purchase website using the wired/wireless Internet by a first user equipment;
transmitting an authentication identifier of the first user equipment to a web server that provides the product purchase website for a purchase of a product by the first user equipment;
determining whether the first user equipment is authenticated or not by comparing the authentication identifier received from the first user equipment and an authentication comparison identifier which is an authentication identifier previously registered and stored in a database of the web server, by the web server;
authenticating the first user equipment by the web server when the received authentication identifier and the stored authentication comparison identifier are identical to each other, forming a personal web page including the authentication identifier and a price barcode of the product, and transmitting the personal web page to the first user equipment;
receiving information obtained by scanning the price barcode of the product included in the personal web page of the first user equipment from the first user equipment by the Value-Added Network (VAN) server to perform a payment;
requesting to remove the personal web page from the web server by the VAN server; and
removing the personal web page by the web server.

2. The electronic commercial method according to claim 1, further comprising:
changing the authentication identifier of the personal web page to an authentication identifier of a second user equipment by the first user equipment, receiving the personal web page in which the authentication identifier is changed from the first user equipment by the web server to transmit the personal web page to the second user equipment, after the authenticating of the first user equipment.

3. The electronic commercial method according to claim 2, further comprising:
receiving information obtained by scanning the price barcode of the product included in the personal web page of the second user equipment from the second user equipment by the Value-Added Network (VAN) server, and performing a payment.

4. The electronic commercial method according to claim 2, wherein the receiving of the personal web page in which the authentication identifier is changed from the first user equipment by the web server to transmit the personal web page to the second user equipment further comprises receiving information of the changed personal web page by the web server, and including a URL of the personal web page on notification information notifying of the change of the personal web page to transmit the information to the second user equipment.

5. The electronic commercial method according to claim 4, wherein the including of the URL of the personal web page on notification information notifying of the change of the personal web page to transmit the information to the second user equipment further includes transmitting the notification information to the second user equipment using SMS or push notification by the web server.

6. The electronic commercial method according to claim 1, wherein the authentication identifier is a unique number of the first user equipment, a phone number, or a user ID and a password.

7. An electronic commercial system using a personal page including a price barcode, comprising:
a first user equipment that connects to a product purchase website using a wired/wireless Internet and transmits an authentication identifier for a purchase of a product;
a web server that determines whether the first user equipment is authenticated or not by comparing the authentication identifier received from the first user equipment and an authentication comparison identifier which is an authentication identifier previously registered and stored in a database of the web server that provides a product purchase website, authenticates the first user equipment when the received authentication identifier and the previously stored authentication comparison identifier are identical to each other, forms a personal web page including the authentication identifier and a price barcode of the product, and transmits the personal web page to the first user equipment; and
a Value-Added Network (VAN) server that receives information obtained by scanning the price barcode of the product included in the personal web page of the first user equipment to perform a payment and requests to remove the personal web page from the web server.

8. The electronic commercial system according to claim 7, wherein the web server includes:
a database in which a plurality of authentication comparison identifiers of user equipments are previously registered and stored;
an authentication processing unit that determines whether the first user equipment is authenticated or not by comparing the authentication identifier received from the first user equipment and authentication comparison identifiers previously registered and stored in a database of the web server, and authenticates the first user equipment when the received authentication identifier and the previously stored authentication comparison identifier are identical to each other; and
a personal web page creating unit that forms a personal web page including the authentication identifier and a price barcode of the product, and transmits the personal web page to the first user equipment.

9. The electronic commercial system according to claim 8,
wherein the personal web page creating unit receives data in which the authentication identifier of the personal web page is changed to an authentication identifier of a second user equipment, creates the personal web page by applying the received data, and transmits the created personal web page to the second user equipment, and
wherein the VAN server receives information obtained by scanning the barcode of the product included in the personal web page of the second user equipment from the second user equipment to perform a payment.

10. The electronic commercial system according to claim 7, wherein the authentication identifier is a unique number of the first user equipment, a phone number, or a user ID and a password.
